(19) United States
(12) Patent Application Publication
(10) Pub. No.: US 2017/0059423 A1
(43) Pub. Date: Mar. 2, 2017

(54) SENSOR INFORMATION COLLECTING APPARATUS

(71) Applicant: MINEBEA CO., LTD., Nagano (JP)

(72) Inventor: Shinichi SUZUKI, HAMAMATSU-SHI (JP)

(21) Appl. No.: 15/251,714

(22) Filed: Aug. 30, 2016

(30) Foreign Application Priority Data
Sep. 2, 2015 (JP) 2015-173126

(51) Int. Cl. G01L 1/22

(52) U.S. Cl. CPC G01L 1/22; H04W 84/18

(57) ABSTRACT

A sensor information collecting apparatus includes: a sensor module; a sensor amplifier that is configured to be in an operation stop mode in a static state; an acceleration sensor that outputs a first start signal; a controller that is configured to be in a sleep mode in the static state, and operates, when the first start signal is received from the acceleration sensor or when an interrupt signal is received from a realtime clock, to output a second start signal to allow the sensor amplifier to start to operate, control reading of the detection data of the sensor module, and store the read detection data in a memory; a power supply unit that is configured to be in the operation stop mode in the static state, and starts to operate by receiving the second start signal from the controller to supply the power supply voltage to the sensor amplifier; and a battery that supplies a battery voltage to the acceleration sensor, the controller, and the power supply unit.

### BACKGROUND OF THE DISCLOSURE

1. Field of the Invention

The present invention relates to a sensor information collecting apparatus, and more particularly, to a sensor information collecting apparatus that operates using a battery.

2. Description of the Related Art

In a sensor information collecting apparatus that measures fatigue deterioration of an infrastructure structure in a maintenance-free state for 10 years by using a battery as a voltage source and accumulates data, a wired system and a wireless system are considered as a means that reads data of fatigue deterioration information accumulated regularly (for example, every several years).

In the wired system, it is necessary to disassemble an apparatus configured to be dustproof and waterproof and to extract data. Therefore, since the wired system deviates from the original concept of the apparatus which is free in maintenance, work for reading data may be complicated and may not realistic.

In the wireless system, in order to communicate with a wireless communication module installed in an apparatus, the wireless communication module is always allowed to be in a standby state and receives a read request signal of accumulated data, so that the accumulated data is allowed to be transmitted from the wireless communication module for the purpose of reading. In this way, the wireless communication module is always in the standby state, resulting in a problem that power consumption of a battery is large and thus the lifetime of the battery, which is free in maintenance for 10 years, is shortened.

On the other hand, there has been disclosed a strain measuring system that reduces the consumption of a power supply means. An example of such system is disclosed in JP-A-2008-234361.

In JP-A-2008-234361, an advantage of such configuration is described that, “in a master unit remote from a slave unit installed in a measuring place of a measuring site, since a physical quantity generated in the measuring place of the site can be precisely grasped and a physical quantity in a place including a strain gage type sensor is measured in response to the size of a physical quantity transmitted from the previous slave unit at a time interval determined by the master unit and is transmitted to the master unit from the slave unit, a measurement time interval is reasonably changed in response to the size of a physical quantity in the measuring site. Accordingly, it is possible to provide a strain measuring system capable of reasonably performing the reduction of the consumption of the power supply means and the precise acquirement of accumulated data” (paragraph [0011]).

However, the slave unit disclosed in JP-A-2008-234361 is controlled to be measured at the time interval determined by the master unit, resulting in a problem that the system configuration of the master unit and the slave unit becomes large and the slave unit is not able to perform a low power consumption operation by itself. Moreover, the slave unit and the master unit need to be always synchronized with each other, resulting in a problem that the system is complicated.

### SUMMARY OF THE INVENTION

One of objects of the present invention is to provide a sensor information collecting apparatus which has a simple configuration and can independently suppress power consumption of a battery.

According to an illustrative embodiment of the present invention, there is provided a sensor information collecting apparatus including: a sensor module including a sensor; a sensor amplifier that is configured to be in an operation stop mode in a static state, and starts to operate by receiving a power supply voltage to output detection data detected by the sensor as sensor information; an acceleration sensor that outputs a first start signal when acceleration equal to or more than a first threshold value is detected; a controller that is configured to be in a sleep mode in the static state, and operates, when the first start signal is received from the acceleration sensor or when an interrupt signal is received from a realtime clock, to output a second start signal to allow the sensor amplifier to start to operate, control reading of the detection data of the sensor module, and store the read detection data in a memory; a power supply unit that is configured to be in the operation stop mode in the static state, and starts to operate by receiving the second start signal from the controller to supply the power supply voltage to the sensor amplifier; and a battery that supplies a battery voltage to the acceleration sensor, the controller, and the power supply unit.

### BRIEF DESCRIPTION OF THE DRAWINGS

In the accompanying drawings:

FIG. 1 is a functional block diagram illustrating a configuration of a sensor information collecting apparatus according to the present embodiment;

FIG. 2 is a perspective view illustrating an example of the sensor information collecting apparatus according to the present embodiment;

FIG. 3 is a flowchart illustrating a processing flow of the sensor information collecting apparatus according to the present embodiment;

FIG. 4 is a flowchart illustrating a processing flow of the sensor information collecting apparatus according to the present embodiment; and

FIG. 5 is a diagram illustrating correspondence between a detection value of an acceleration sensor and a gravity acceleration measurement value due to an earthquake.

### DETAILED DESCRIPTION

Next, an embodiment for embodying the present invention (hereinafter, referred to as a “present embodiment”) will be described in detail with reference to each of drawings.

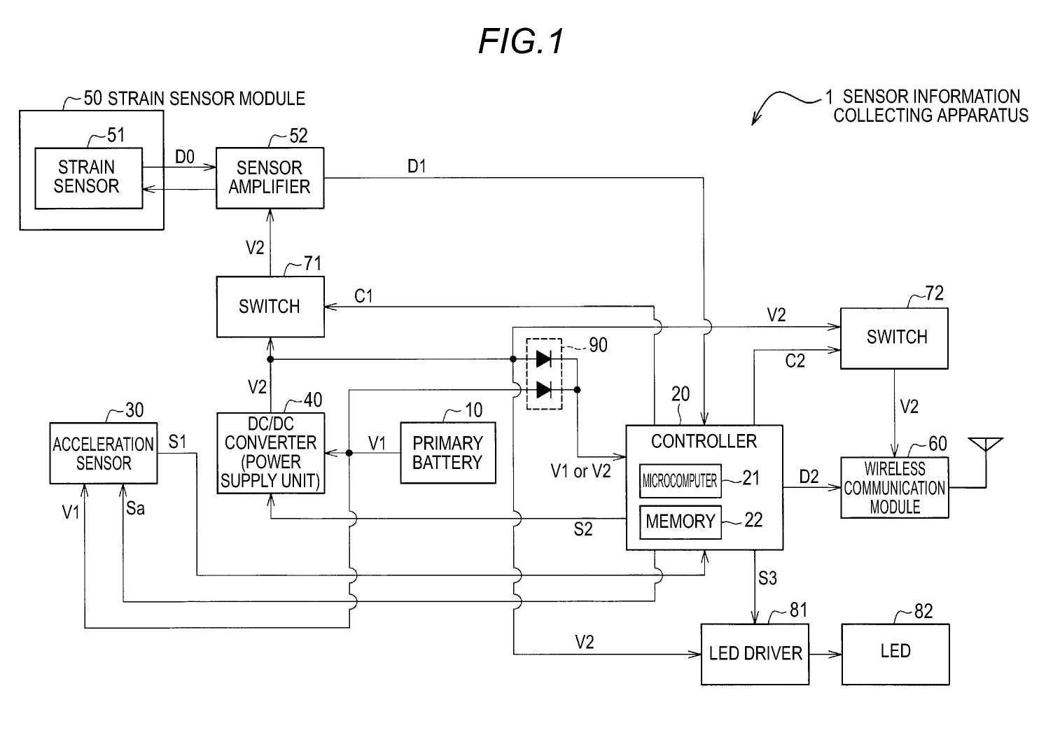

FIG. 1 is a functional block diagram illustrating the configuration of a sensor information collecting apparatus 1 according to the present embodiment.

As illustrated in FIG. 1, the sensor information collecting apparatus 1 according to the present embodiment includes a primary battery 10, a controller 20 having a microcomputer (processor) 21 and a memory 22, an acceleration sensor (accelerometer) 30, a DC/DC converter 40, a strain sensor module 50, a sensor amplifier 52, a wireless communication module 60, an OR circuit 90, and switches 71 and 72. Furthermore, the sensor information collecting apparatus 1 of the present embodiment includes an LED (Light Emitting Diode) driver (an example of an indicator driver) 81 and a LED (an example of an indicator) 82.

The sensor information collecting apparatus 1, for example, is an apparatus that operates in a maintenance-free state for 10 years by employing the primary battery (an example of a battery) 10 as a voltage source, and collects sensor information. In a static state, in order to reduce power consumption of the primary battery 10, the sensor information collecting apparatus 1 allows only the controller 20 (including the microcomputer 21 and the memory 22) to be in a sleep mode and allows the acceleration sensor 30 to enter a wake-up mode. The wake-up mode is a mode in which, when vibration equal to or more than a predetermined value or collision vibration equal to or more than a predetermined value is detected, setting for outputting information (a “first start signal” to be described later) indicating the detection is represented and acceleration data is not measured. The sensor information collecting apparatus 1 allows the other elements (the DC/DC converter (an example of a power supply unit) 40, the strain sensor module (an example of a sensor module) 50, the sensor amplifier 52, the wireless communication module 60, the LED driver 81 and the like, which will be described later) to be in an operation stop mode.

As described above, in the static state, the sensor information collecting apparatus 1 according to the present embodiment allows only the controller 20 to be in the sleep mode in order to reduce the power consumption of the primary battery 10. When the acceleration sensor 30 has detected vibration (acceleration) equal to or more than a predetermined value inclusive of an earthquake and at a time interval (when an interrupt signal is received from a realtime clock) set in advance, the sensor information collecting apparatus 1 starts to operate a component circuit and collects sensor information.

The sensor information collecting apparatus 1, for example, is constantly installed in an infrastructure structure such as an iron bridge, a tunnel, and a jet fan installed in the tunnel and detects looseness of bolts and fatigue deterioration of the structure by using a strain sensor (a strain sensor module), which will be described in the following embodiment. However, sensor information detected by the sensor module is not limited thereto, and it is sufficient if it is sensor information for detecting fatigue deterioration of a structure for a long time (several years) by using an ultrasonic sensor, an acoustic sensor, a vibration sensor, a load sensor, a radiation sensor and the like.

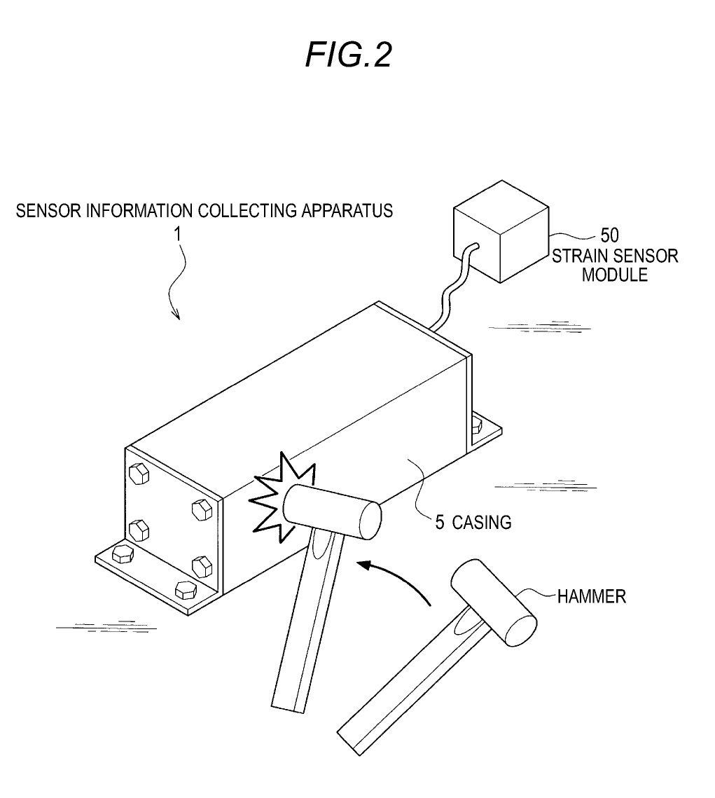

FIG. 2 is a perspective view illustrating an example of the sensor information collecting apparatus 1 according to the present embodiment.

As illustrated in FIG. 2, the sensor information collecting apparatus 1 is configured by connecting the strain sensor module 50 to a casing 5. The casing 5 stores the aforementioned primary battery 10, the controller 20, the acceleration sensor 30, the wireless communication module 60, the LED driver 81 and the like therein. Although not illustrated in the drawing, the LED (an example of an indicator) 82 may be arranged at any one of the casing 5 side and the strain sensor module 50 side.

In the related art, a hammering test is performed in order to confirm fatigue deterioration of an infrastructure structure and the like, and a behavior of “hitting” (external impact) the structure is general in the test site. In the present invention, in view of this, in order to read (collect) detection data (sensor information) obtained by measuring the fatigue deterioration of the structure in the sensor information collecting apparatus 1, the casing 5 of the sensor information collecting apparatus 1, for example, is “hit” by a hammer and the like as illustrated in FIG. 2, so that the sensor information collecting apparatus 1 is started to operate in addition to external impact and the accumulated data (the sensor information) is allowed to be transmitted from the wireless communication module 60 for the purpose of reading. The acceleration sensor 30 waits in the wake-up mode (not in an operation mode) and the casing 5 is hit by a hammer and the like, so that the acceleration sensor 30 detects collision equal to or more than a predetermined value and transmits a start signal (the first start signal) to the controller 20.

In this way, the sensor information collecting apparatus 1 according to the present embodiment can be installed in a place with no power supply infrastructure structure and reduces the power consumption of the primary battery 10, so that it is possible to prevent the lifetime of the primary battery 10 from being impaired. Furthermore, extraction of data accumulated in the sensor information collecting apparatus 1 can be simply performed in a wireless manner.

Next, the operations of the elements of the sensor information collecting apparatus 1 according to the present embodiment will be described in detail with reference to FIG. 1.

A battery voltage V1 of the primary battery 10 is supplied to the controller 20 and the acceleration sensor 30 in a static state, and a power supply voltage V2 is supplied to the elements (the controller 20, the sensor amplifier 52, the wireless communication module 60, the LED driver 81 and the like) via the DC/DC converter 40 at the time of detection of sensor information, and the like.

The acceleration sensor 30 operates in the wake-up mode of outputting the fact that acceleration equal to or more than a predetermined value is detected, while consuming excessively low power. Specifically, in the case in which a predetermined second threshold value (a predetermined second acceleration) has been set in the acceleration sensor 30, when acceleration equal to or more than the predetermined second threshold value (the predetermined second acceleration) is detected, the acceleration sensor 30 outputs a first start signal (S1-1: a microcomputer start signal) for allowing the microcomputer 21 to start to operate to the controller 20. In the case in which a predetermined first threshold value (a predetermined first acceleration) has been set in the acceleration sensor 30, when acceleration equal to or more than the predetermined first threshold value (the predetermined first acceleration) higher than the second threshold value is detected, the acceleration sensor 30 outputs a first start signal (S1-2: a detection start trigger signal) for allowing the sensor amplifier 52 and the like to start to operate to the controller 20. In FIG. 1, the start signals S1-1 and S1-2 outputted from the acceleration sensor 30 to the controller 20 are collectively referred to as a first start signal S1.

The predetermined second threshold value (the predetermined second acceleration) and the predetermined first threshold value (the predetermined first acceleration) are set to satisfy “the predetermined second acceleration<the predetermined first acceleration”. When the acceleration sensor 30 has detected the predetermined second acceleration or more, the microcomputer 21 is started to operate, and when the acceleration sensor 30 has received the predetermined first acceleration (for example, acceleration corresponding to an earthquake with a seismic intensity of lower 5 or more), detection of sensor information is allowed to be performed by the strain sensor module 50 and the like. Details of the first acceleration and the second acceleration will be described later.

The controller 20 includes the microcomputer 21 and the memory 22, and for example, is configured by an LSI (Large Scale Integration) circuit. The configuration of the controller is not limited thereto, and the controller may have a configuration in which the memory is included in the microcomputer.

The controller 20 enters a sleep mode in a static state, outputs a detection acceleration setting signal Sa to the acceleration sensor 30, and sets the predetermined second threshold value (the predetermined second acceleration) in the acceleration sensor 30. When the first start signal (S1-1: the microcomputer start signal) indicating the detection of acceleration equal to or more than the predetermined second threshold value (the predetermined second acceleration) is received from the acceleration sensor 30, the controller 20 outputs the detection acceleration setting signal Sa to the acceleration sensor 30 and sets the predetermined first threshold value (the predetermined first acceleration) in the acceleration sensor 30.

In a process after the first start signal (S1-1: the microcomputer start signal) has been received from the acceleration sensor 30, when the first start signal (S1-2: the detection start trigger signal) has been received from the acceleration sensor 30 or when the interrupt signal is received from a realtime clock, the controller 20 outputs a second start signal S2 to the DC/DC converter 40 and starts the operation of the DC/DC converter 40. The second start signal S2 indicates a signal that is outputted by the microcomputer 21 of the controller 20 in order to allow the DC/DC converter 40 to start to operate.

When the first start signal (S1-2: the detection start trigger signal) indicating the detection of acceleration equal to or more than the predetermined first threshold value (the predetermined first acceleration) has been received from the acceleration sensor 30 or when the interrupt signal is received from a realtime clock, the controller 20 controls the reading of sensor information of the sensor amplifier 52 and accumulates (stores) the sensor information in the memory 22 (a data detection process). On the other hand, when the first start signal (S1-2: the detection start trigger signal) indicating the detection of the acceleration equal to or more than the predetermined first threshold value (the predetermined first acceleration) has not been received, the controller 20 outputs the second start signal S2 to the DC/DC converter 40 to start the operation of the DC/DC converter 40, allows the wireless communication module 60 to start to operate, and then transmits the accumulated sensor information (also including address information, time information and the like) via the wireless communication module 60 (an accumulated data transmission process).

Moreover, when a value of the accumulated sensor information exceeds a predetermined threshold value (a predetermined value for determining that it is necessary to issue alarm information), the controller 20 may output a lighting signal (an example of a control signal) S3 to the LED driver 81 and may allow the LED driver 81 to turn on/off the LED 82. In this way, it is possible to notify a manager and the like that the value of the sensor information has reached an abnormal level.

The DC/DC converter 40 is connected to the primary battery 10, starts to operate by the second start signal S2 from the controller 20, supplies a voltage (the power supply voltage V2) to the sensor amplifier 52 via the switch 71 and to the wireless communication module 60 via the switch 72, and supplies the voltage (the power supply voltage V2) to the controller 20 and the LED driver 81.

The battery voltage V1 of the primary battery 10 and the power supply voltage V2 outputted from the DC/DC converter 40 are supplied to the controller 20 via the diode OR circuit 90.

That is, until the DC/DC converter 40 is started to operate by the second start signal S2, the battery voltage V1 of the primary battery 10 is supplied to the controller 20, and at the time at which the DC/DC converter 40 has been started to operate, the power supply voltage V2 is supplied to the controller 20 in order to match an output voltage and a voltage level of the sensor amplifier 52 with each other.

The switch 71 receives an operation instruction signal C1 from the controller 20, and supplies the output voltage (the power supply voltage V2) of the DC/DC converter 40 to the sensor amplifier 52.

The strain sensor module 50 includes a strain sensor 51 and a structure in which the strain sensor 51 is mounted. The sensor amplifier 52 receives a voltage via the switch 71, thereby amplifying a detection value D0 by the strain sensor 51 and outputting detection data (sensor information; D1) to the controller 20.

The switch 72 receives an operation instruction signal C2 from the controller 20, and supplies the output voltage (the power supply voltage V2) of the DC/DC converter 40 to the wireless communication module 60.

The wireless communication module 60 transmits the detection data D1, the address information, the time information and the like accumulated in the memory 22 to an exterior under the control of the controller 20.

Next, the operation of the sensor information collecting apparatus 1 will be described (appropriately see FIG. 1).

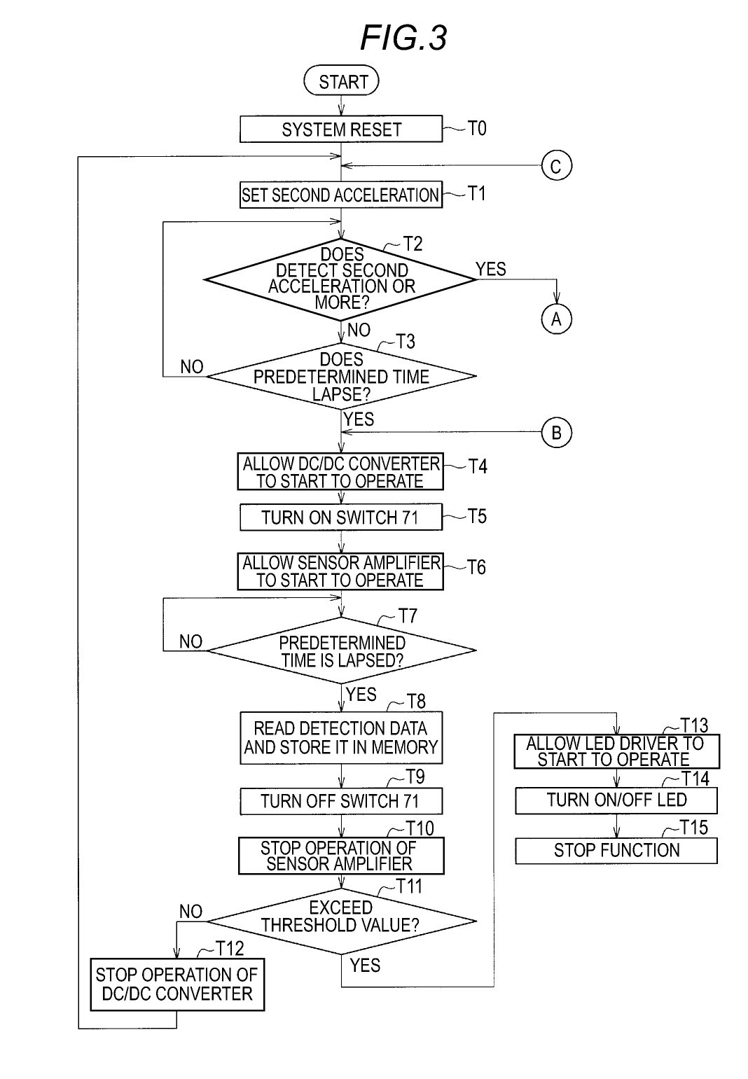

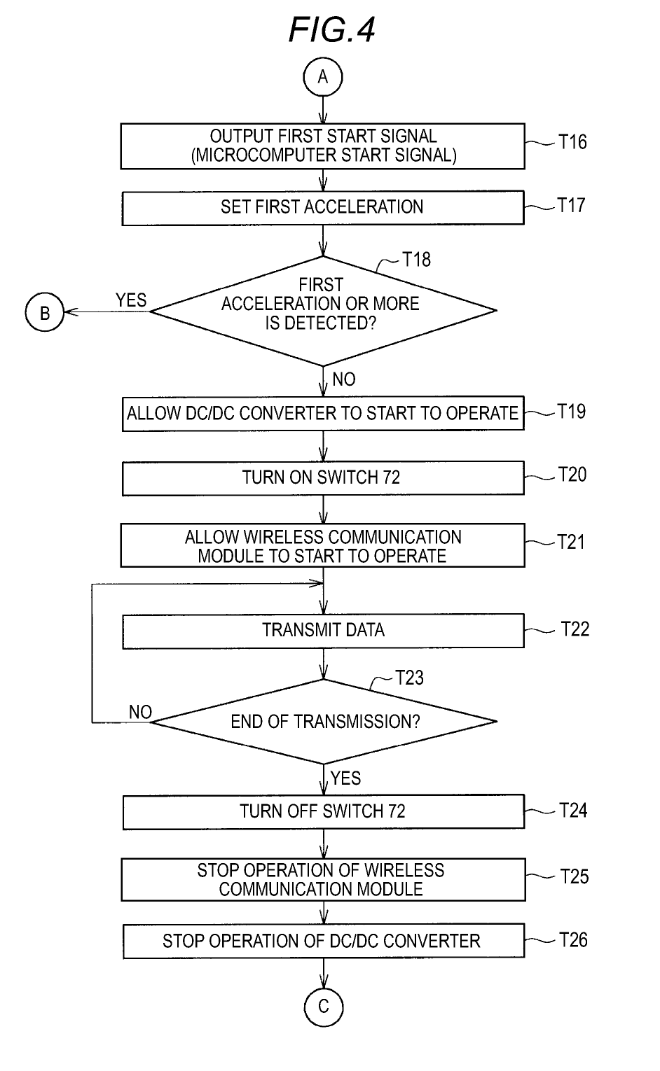

FIG. 3 and FIG. 4 are flowcharts illustrating processing flows of the sensor information collecting apparatus 1 according to the present embodiment.

First, in the operation of the sensor information collecting apparatus 1, system reset is performed as a setting state (an initial state) in a static state (step T0 of FIG. 3).

In this system reset, as a state in the static state of the sensor information collecting apparatus 1, the controller 20 enters the sleep mode and the acceleration sensor 30 enters the wake-up mode. The other elements (the DC/DC converter 40, the sensor amplifier 52, the wireless communication module 60, the LED driver 81 and the like) enter the operation stop mode.

Subsequently, the microcomputer 21 of the controller 20 sets the predetermined second threshold value (the predetermined second acceleration) in the acceleration sensor 30 (step T1).

Next, the microcomputer 21 of the controller 20 determines whether the acceleration sensor 30 operating in the wake-up mode has detected acceleration equal to or more than the predetermined second threshold value (the predetermined second acceleration) (step T2). When the acceleration sensor 30 has detected the acceleration equal to or more than the predetermined second threshold value (the predetermined second acceleration) (YES in step T2), the microcomputer 21 proceeds to step T16 of FIG. 4. However, when the acceleration sensor 30 has not detected the acceleration equal to or more than the predetermined second threshold value (the predetermined second acceleration) (NO in step T2), the microcomputer 21 proceeds to next step T3.

In step T3, the microcomputer 21 of the controller 20 determines whether a predetermined time (for example, 24 hours: a detection cycle of the strain sensor 51) has lapsed. The controller 20, for example, can determine whether the predetermined time has lapsed according to whether the interrupt signal based on a realtime clock embedded in the microcomputer 21 has been received. In this determination, when the predetermined time has not lapsed (NO in step T3), the microcomputer 21 returns to step T2. However, when the predetermined time has lapsed (YES in step T3), the controller 20 starts to operate from the sleep mode and the microcomputer 21 proceeds to next step T4.

Subsequently, the microcomputer 21 outputs the second start signal S2 to the DC/DC converter 40, thereby allowing the DC/DC converter 40 to start to operate (step T4).

Then, the microcomputer 21 outputs the operation instruction signal C1 to the switch 71, thereby turning on the switch 71 (step T5), and supplies the sensor amplifier 52 with the output voltage (the power supply voltage V2) of the DC/DC converter 40, thereby allowing the sensor amplifier 52 to start to operate (step T6).

Next, the microcomputer 21 determines whether a predetermined time (for example, five seconds: a measurement time by the strain sensor 51) has lapsed after the sensor amplifier 52 is started to operate (step T7). When the predetermined time has not lapsed (NO in step T7), the microcomputer 21 waits until the predetermined time lapses. However, when the predetermined time has lapsed (YES in step T7), the microcomputer 21 proceeds to next step T8.

In step T8, the microcomputer 21 reads the detection data D1 obtained by amplifying the detection value (time-dependent fatigue deterioration data D0) of the strain sensor 51 by the sensor amplifier 52 and the memory 22 stores the detection data D1.

Subsequently, the microcomputer 21 stops the output of the operation instruction signal C1 to the switch 71 so as to turn off the switch 71 (step T9), and stops the operation of the sensor amplifier 52 (step T10).

Then, the microcomputer 21 determines whether a predetermined threshold value (a value requiring an alarm) has been exceeded with reference to the detection data D1 stored in the memory 22 (step T11). When it is determined that the predetermined threshold value has not been exceeded (NO in step T11), the microcomputer 21 stops the operation of the DC/DC converter 40 (step T12), proceeds to the state in the static state, and returns to the process of step T1. However, when it is determined that the predetermined threshold value has been exceeded (YES in step T11), the microcomputer 21 proceeds to next step T13.

In step T13, the microcomputer 21 outputs the lighting signal (for example, a pulse signal) to the LED driver 81, thereby allowing the LED driver 81 to start to operate. Then, the microcomputer 21 allows the LED 82 to be turned on/off by the control of the LED driver 81 until the power of the primary battery 10 is consumed (step T14), and finally stops the functions of the entire sensor information collecting apparatus 1 and ends the procedure (step T15).

In step T2, when the acceleration sensor 30 has detected the acceleration equal to or more than the predetermined second threshold value (the predetermined second acceleration) (YES in step T2), the microcomputer 21 proceeds to step T16 of FIG. 4.

In step T16, the acceleration sensor 30 outputs, to the controller 20, the first start signal (S1-1: the microcomputer start signal) indicating the detection of the acceleration equal to or more than the predetermined second threshold value (the predetermined second acceleration).

When the first start signal (S1-1: the microcomputer start signal) is received, the microcomputer 21 outputs the detection acceleration setting signal Sa for setting the predetermined first threshold value (the predetermined first acceleration) to the acceleration sensor 30, and sets the predetermined first threshold value (the predetermined first acceleration) in the acceleration sensor 30 (step T17).

The microcomputer 21 determines whether the acceleration sensor 30 has detected acceleration equal to or more than the predetermined first threshold value (the predetermined first acceleration) in a predetermined time (for example, three minutes: a time for detecting an earthquake and the like) (step T18). When the acceleration equal to or more than the predetermined first threshold value (the predetermined first acceleration) is detected (YES in step T18), the acceleration sensor 30 outputs, to the controller 20, the first start signal (S1-2: the detection start trigger signal) for allowing the sensor amplifier 52 and the like to start to operate.

Then, the microcomputer 21 proceeds to the process of step T4 of FIG. 3, and performs processes of outputting the second start signal S2 to the DC/DC converter 40 so that the DC/DC converter 40 starts to operate, storing the detection data D1 obtained by amplifying the detection value of the strain sensor 51 by the sensor amplifier 52 in the memory 22, and the like (the data detection process) (steps T4 to T15).

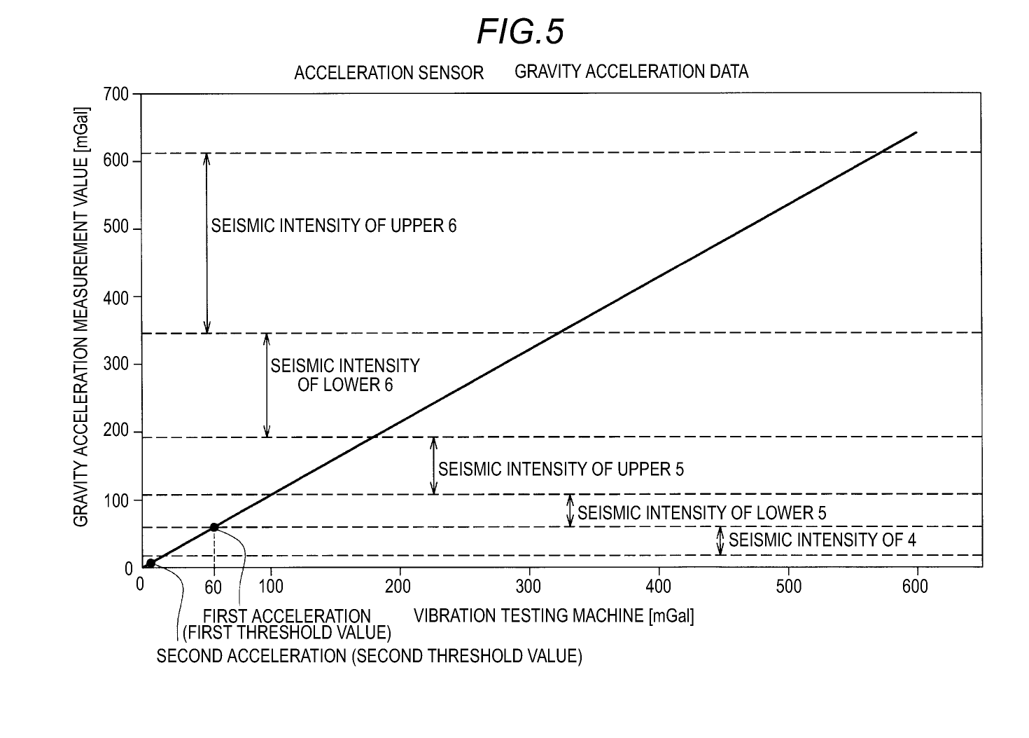

As described above, the predetermined first threshold value (the predetermined first acceleration) is a value larger than the predetermined second threshold value (the predetermined second acceleration), and for example, a value corresponding to acceleration when detecting an earthquake with a seismic intensity of lower 5 or more is set. As illustrated in FIG. 5, in the case of the earthquake with a seismic intensity of lower 5 or more, acceleration equal to or more than approximately 60 mGal is detected. Thus, the predetermined first threshold value (the predetermined first acceleration), for example, is set to 50 mGal in consideration of a slight margin, so that it can serve as a trigger for performing a process of detecting the presence or absence of deterioration (for example, looseness and the like of bolts) due to the earthquake of a structure (the earthquake with a seismic intensity of lower 5 or more having an influence on fatigue deterioration of the structure). On the other hand, the predetermined second threshold value (the predetermined second acceleration) is set to a value (acceleration of a level having no influence on fatigue deterioration of a structure) smaller than the predetermined first threshold value (the predetermined first acceleration), for example, 5 mGal. In this way, it is distinguished from the earthquake with a seismic intensity of lower 5 or more having an influence on the fatigue deterioration of the structure and for example, the sensor information collecting apparatus 1 is subjected to “hitting” and the like by a hammer, so that the controller 20 is started to operate and the accumulated detection data D2 can be transmitted by the wireless communication module 60.

Returning to FIG. 4, in step T18, when the acceleration sensor 30 has not detected the acceleration equal to or more than the predetermined first threshold value (the predetermined first acceleration) in the predetermined time (step T18 □No), that is, when the microcomputer 21 has not received the first start signal (S1-2: the detection start trigger signal) in the predetermined time, the microcomputer 21 proceeds to next step T19.

In step T19, the microcomputer 21 outputs the second start signal S2 to the DC/DC converter 40, thereby allowing the DC/DC converter 40 to start to operate.

Then, the microcomputer 21 outputs the operation instruction signal C2 to the switch 72, thereby turning on the switch 72 (step T20), and supplies the wireless communication module 60 with the output voltage (the power supply voltage V2) of the DC/DC converter 40, thereby allowing the wireless communication module 60 to start to operate (step T21).

Subsequently, the microcomputer 21 transmits the detection data D1 stored in the memory 22 and the like (the accumulated data: D2) via the wireless communication module 60 (step T22).

Then, the microcomputer 21 determines whether the transmission of the detection data D1 stored in the memory 22 and the like (the accumulated data: D2) has been ended (step T23). When the transmission has not been ended (NO in step T23), the microcomputer 21 returns to step T22 and continues the transmission.

However, when the transmission has been ended (YES in step T23), the microcomputer 21 stops the output of the operation instruction signal C2 to the switch 72, thereby turning off the switch 72 (step T24), and stops the operation of the wireless communication module 60 (step T25). Then, the microcomputer 21 stops the operation of the DC/DC converter 40 (step T26), proceeds to the state in the static state, and returns to the process of step T1.

In addition, step T11 and steps T13 to T15 are not essential processes, and when the sensor information collecting apparatus 1 does not include the LED driver 81 and the LED 82, step T11 and steps T13 to T15 are not performed. In this case, the sensor information collecting apparatus 1 stops the operation of the sensor amplifier 52 in step T10, performs the operation stop process of the DC/DC converter 40 of step T12, and then returns to the process of step T1.

Instead of turning on/off the LED 82 by the LED driver 81 of steps T13 to T15, the sensor information collecting apparatus 1 may allow the wireless communication module 60 to start to operate, thereby transmitting the detection data D2 having exceeded the predetermined threshold value (the predetermined value requiring an alarm) determined in step T11 to an exterior. Moreover, in addition to the turning on/off of the LED 82 by the LED driver 81 of steps T13 to T15, the sensor information collecting apparatus 1 may allow the wireless communication module 60 to start to operate, thereby transmitting the detection data D2 having exceeded the predetermined threshold value (the predetermined value requiring an alarm) determined in step T11 to an exterior.

As described above, in accordance with the sensor information collecting apparatus 1 according to the present embodiment, the apparatus can be installed in a place with no power supply infrastructure structure and reduces the power consumption of the primary battery 10, so that it is possible to prevent the lifetime of the primary battery 10 from being impaired. Furthermore, acceleration equal to or more than the predetermined second threshold value (the predetermined second acceleration) is allowed to be detected by the acceleration sensor 30 by using a hammer and the like, so that it is possible to allow the wireless communication module 60 to start to operate. Thus, extraction of data accumulated in the sensor information collecting apparatus 1 can be simply performed in a wireless manner. That is, a worker can simply read (collect) accumulated data (sensor information) without requiring an advanced technology (complicated setting and operation). At this time, the worker has an apparatus that receives the accumulated data (the sensor information) in a wireless manner, or installs (and the like) the apparatus on the ground, so that the worker can read (collect) the accumulated data (the sensor information) by oneself. Furthermore, since it is sufficient if the worker hits (and the like) the sensor information collecting apparatus 1, it is possible to collect data without impairing dustproof and waterproof countermeasures of the sensor information collecting apparatus 1.

The present invention is not limited to the aforementioned embodiment, and modification examples can be made without departing the scope of the present invention.

For example, the present embodiment has described that a worker hits the sensor information collecting apparatus 1 by using a hammer and the like (an example of external impact), so that the acceleration sensor 30 outputs the first start signal S1, however, the present invention is not limited to the hammer and if the sensor information collecting apparatus 1 has been installed in a high place, a worker may hit the sensor information collecting apparatus 1 by using a rod and the like. Furthermore, when the sensor information collecting apparatus 1 has been installed in a place where no worker exits around, a robot, instead of the worker, may hit the sensor information collecting apparatus 1 such that the predetermined first threshold value (the predetermined first acceleration) or more is obtained.

Furthermore, the present embodiment has described that the acceleration sensor 30 is embedded in the casing 5 (see FIG. 2) of the sensor information collecting apparatus 1. However, the acceleration sensor 30 may be installed outside the casing 5, and for example, the acceleration sensor 30 may be mounted in a structure in which one side has a metal rod shape and may be configured to be easily able to detect vibration (acceleration). Furthermore, when the sensor information collecting apparatus 1 itself is installed in an infrastructure structure, an elastic body is arranged therebetween, so that vibration (acceleration) may be easily detected by the acceleration sensor 30. In this way, it is possible to easily detect the predetermined second threshold value (the predetermined second acceleration). For example, the sensor information collecting apparatus 1 may be started to operate when a user or a worker shakes the sensor information collecting apparatus 1 with his/her hands.

Moreover, a description will be provided for configurations in which the present invention is not limited to the contents described in the aforementioned embodiment.

(1) A battery provided in the sensor information collecting apparatus 1 is not limited to the primary battery 10, and a secondary battery and the like may be used.

(2) The circuit configuration illustrated in the functional block diagram of the sensor information collecting apparatus 1 of FIG. 1 is an example of the present invention, and the present invention is not limited thereto. For example, an indicator is not limited to the LED 82 and a fluorescent lamp and the like may be used. Furthermore, the configuration of the controller 20 is not limited to the present embodiment, and the controller 20 may have a configuration in which the memory 22 is included in the microcomputer 21.

(3) The processing flows (the flowcharts) of the sensor information collecting apparatus 1 illustrated in FIG. 3 and FIG. 4 are examples of the present invention, and the present invention is not limited thereto. For example, another process may be performed among the steps.

(4) The correspondence between the detection value of the acceleration sensor and the gravity acceleration measurement value due to an earthquake illustrated in FIG. 5 is one of a specific example, and the present invention is not limited thereto.

(5) In the present embodiment, the detection data D1 and the like stored in the memory 22 may be configured to be transmitted by the wireless communication module 60 due to collision (for example, hitting by a hammer and the like) from an exterior. However, the present invention is not limited thereto, and for example, as well as the detection data D1 stored in the memory at the time point at which collision has been received from an exterior, when the collision has been received from the exterior, the strain sensor 51 may read a new detection value, and new detection data may be put into the detection data D1 stored in the memory 22 before the reading and be transmitted by the wireless communication module 60.

According to the present invention, it is possible to provide a sensor information collecting apparatus which has a simple configuration and can independently suppress power consumption of a battery.

What is claimed is:

1. A sensor information collecting apparatus comprising:
a sensor module including a sensor;
a sensor amplifier that is configured to be in an operation stop mode in a static state, and starts to operate by receiving a power supply voltage to output detection data detected by the sensor as sensor information;
an acceleration sensor that outputs a first start signal when acceleration equal to or more than a first threshold value is detected;
a controller that is configured to be in a sleep mode in the static state, and operates, when the first start signal is received from the acceleration sensor or when an interrupt signal is received from a realtime clock, to output a second start signal to allow the sensor amplifier to start to operate, control reading of the detection data of the sensor module, and store the read detection data in a memory;
a power supply unit that is configured to be in the operation stop mode in the static state, and starts to operate by receiving the second start signal from the controller to supply the power supply voltage to the sensor amplifier; and
a battery that supplies a battery voltage to the acceleration sensor, the controller, and the power supply unit.

2. The sensor information collecting apparatus according to claim 1 further comprising:
a wireless communication module that is configured to be in the operation stop mode in the static state,
wherein, when acceleration equal to or more than a second threshold value that is lower than the first threshold value is detected by external impact, the acceleration sensor outputs the first start signal,
wherein, when the first start signal is received, the controller outputs the second start signal to allow the power supply unit to start to operate, and wherein the wireless communication module starts to operate by receiving the power supply voltage from the power supply unit, and transmits the detection data stored in the memory based on an instruction of the controller.

3. The sensor information collecting apparatus according to claim 1 further comprising:
a wireless communication module that is configured to be in the operation stop mode in the static state,
wherein, when a value of the detection data stored in the memory exceeds a predetermined value, the controller supplies the power supply voltage from the power supply unit to allow the wireless communication module to start to operate, and
wherein the wireless communication module starts to operate by receiving the power supply voltage from the power supply unit, and transmits the detection data based on the instruction of the controller.

4. The sensor information collecting apparatus according to claim 1 further comprising:
an indicator; and
an indicator driver that is configured to be in the operation stop mode in the static state and controls the indicator,
wherein, when the value of the detection data stored in the memory exceeds the predetermined value, the controller supplies the power supply voltage from the power supply unit to allow the indicator driver to start to operate, and
wherein the indicator driver starts to operate by receiving the power supply voltage from the power supply unit, and controls the indicator to perform indication for notifying that the value of the detection data is equal to or more than the predetermined value, based on a control signal of the controller.

5. The sensor information collecting apparatus according to claim 1,
wherein the sensor module includes a strain sensor that detects strain which is a measurement target and generates the detection data.
